(19) United States
(12) Patent Application Publication
(10) Pub. No.: US 2006/0112313 A1
(43) Pub. Date: May 25, 2006

(54) Bootable virtual disk for computer system recovery

(76) Inventors: Thomas M. Tripp, El Dorado Hills, CA (US); Eric Owhadi, Tomball, TX (US); Christophe Le Rouzo, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/986,644

(22) Filed: Nov. 12, 2004

(51) Int. Cl. G06F 11/00

(52) U.S. Cl. 714/36

(57) ABSTRACT

A method of operating a computer including initiating an operating system boot process utilizing critical files stored in associated standard locations on a first peripheral device. After a successful boot, files critical to the standard operating system boot process are copied from the standard locations to a boot image residing on the first peripheral device. The computer can optionally boot from the boot image during a subsequent operating system boot process.

### TECHNICAL FIELD

This invention relates to the field of computer maintenance. In particular, this invention is drawn to the maintenance of a computer using a boot image.

### BACKGROUND

Computer systems typically include hardware components such as processors, power supplies, nonvolatile storage, peripheral devices, etc. Some of the components have firmware that can be modified by the user to tailor the component configuration for the particular system it is installed within. Application software for any number of applications may also be installed. Typically such software is installed on a magnetic or optical disk for nonvolatile storage.

Unfortunately, the computer system can malfunction as a result of either software or hardware problems. Sources of malfunction include failing components, misconfigured components, conflicts between application programs, operating system errors, etc. Exposure of the computer system to sources of malicious software (e.g., viruses, worms, etc.) may also result in malfunction when such software is executed.

Frequently the malfunction is the result of a corrupted or missing critical file. Correction of the malfunction requires the capability of returning the computer to a prior known state, for example, by restoring the critical file.

One recovery approach provides the user with an optical compact disk (CD) containing a restoration program and a trusted version of the critical files. The user may not have a CD drive at their disposal, however. Such peripheral devices may have been deliberately omitted from the computer configuration in order to prevent users from installing unauthorized software. Alternatively, the user may be using a laptop or other mobile system without ready access to a CD drive.

Even if the computer system is provided with a drive to support recovery operations, restoration from the removable media typically eliminates current user-data and re-instates obsolete user specific data and critical files. Although the CD may provide a trusted version of the critical files, the CD frequently does not accurately reflect a recent state of the computer. The user is then forced to rebuild or re-install various software components to bring the computer system up-to-date with current drivers and operating system components. This approach is somewhat impractical when dealing with a large base of computer systems because of the need to distribute and maintain the removable media.

### SUMMARY

In view of limitations of known systems and methods, various methods and apparatus for operating a computer are described. In one embodiment, a method of operating a computer includes initiating a standard operating system boot process utilizing critical files stored in associated standard locations on a first peripheral device. The critical files are copied from the first peripheral device into a boot image residing on the first peripheral device after a successful boot. The computer can optionally boot from the boot image during a subsequent operating system boot process.

In another embodiment, a method of operating a computer includes initiating a computer operating system boot from a boot image residing on a first peripheral device. Files critical to a standard operating system residing elsewhere on the first peripheral device are copied from the boot image to associated standard locations on the first peripheral device after a successful boot from the boot image.

### BRIEF DESCRIPTION OF THE DRAWINGS

FIG. 1 illustrates one embodiment of a method for enabling restoration of files critical to a boot process.

FIG. 2 illustrates one embodiment of updating critical operating system boot files residing within a boot image.

FIG. 3 illustrates one embodiment of restoring critical operating system boot files from a boot image to associated standard locations on a first peripheral device.

FIG. 4 illustrates one embodiment of a network environment.

FIG. 5 illustrates one embodiment of a computer.

FIG. 6 illustrates one embodiment of a computer boot process.

FIG. 7 illustrates one embodiment of file for generating an operating system selection menu.

FIG. 8 illustrates one embodiment of a partitioned hard disk.

FIG. 9 illustrates one embodiment of a hard disk partition having a boot image.

FIG. 10 illustrates one embodiment of a boot image.

FIG. 11 illustrates one embodiment of a method for booting from a boot image.

FIG. 12 illustrates one embodiment of a method of booting a boot image from a hard drive using BIOS calls.

FIG. 13 illustrates one embodiment of a method for enabling restoration of files critical to a boot process.

### DETAILED DESCRIPTION

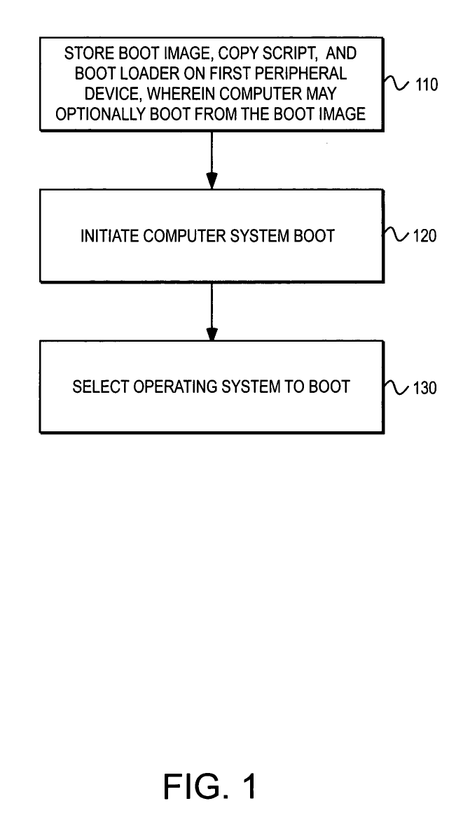

FIG. 1 illustrates one embodiment of a method for enabling restoration of files critical to a boot process. In step 110, a boot loader, copy script, and a boot image are stored on a first peripheral device of the computer system. In one embodiment, the first peripheral device is a hard disk drive.

The boot image includes an operating system and critical files associated with booting the operating system. The boot image is stored as a contiguous file on the first peripheral device.

The boot loader is an executable program (e.g., “bld.com”) that configures the computer system to perceive the boot image as a peripheral device when executed. At the time the boot loader is stored on the first peripheral device, the boot loader may need to be patched to indicate the physical location of the boot image on the first peripheral device. Alternatively, the boot loader may dynamically determine the location of the boot image.

In order to ensure that the boot image and boot loader are not fragmented by a file system or disk maintenance application, the boot image and boot loader are provided with a file system attribute to prevent or protect from fragmentation. For example, the boot image and boot loader may be provided with a “system” attribute to identify them as critical files that should not be fragmented.

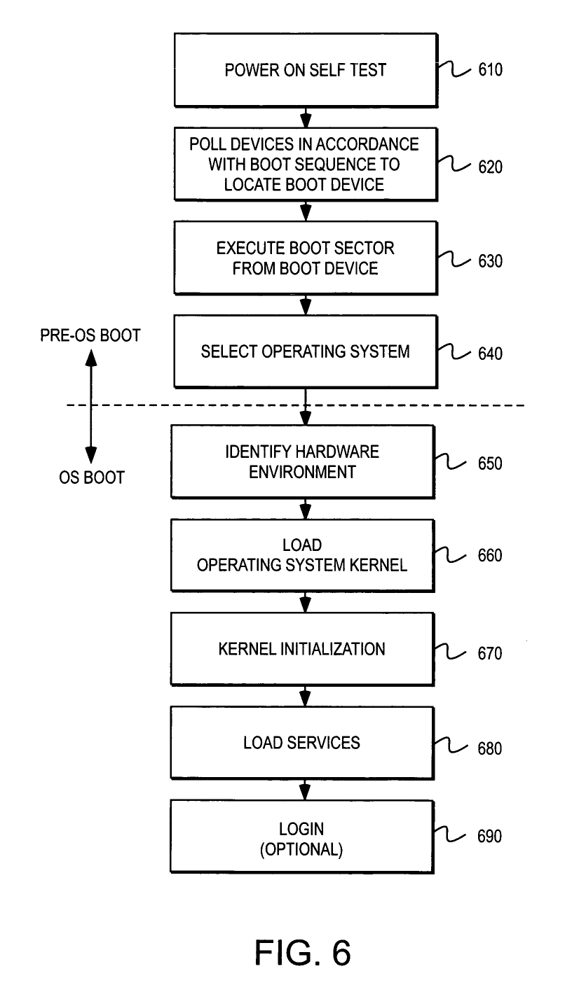

In step 120 a computer system boot process is initiated. The boot process is described more fully with respect to FIG. 6. Typically, the user may select from one or more operating systems. In this case the user will be provided with the ability to either boot from the boot image or to boot a standard operating system using the critical files stored in associated standard locations (i.e., other than the boot image) on the first peripheral device.

In Microsoft® Windows®-type operating systems, the “boot.ini” file is the file used to specify selectable operating systems. (Microsoft Corporation located in Redmond, Wash. is the manufacturer of Windows® brand operating systems). At the time the boot loader, copy script, and boot image are stored on the first peripheral device in step 110, the “boot.ini” file may be modified to provide an option to boot from the boot image. Once the boot process is initiated, an operating system is selected for booting in step 130. Once the boot image is stored on the first peripheral device, there will be at least two possible operating systems to be booted. The user may select to boot from the operating system within the boot image. Alternatively, the user may select to boot using the operating system already residing on the first peripheral device.

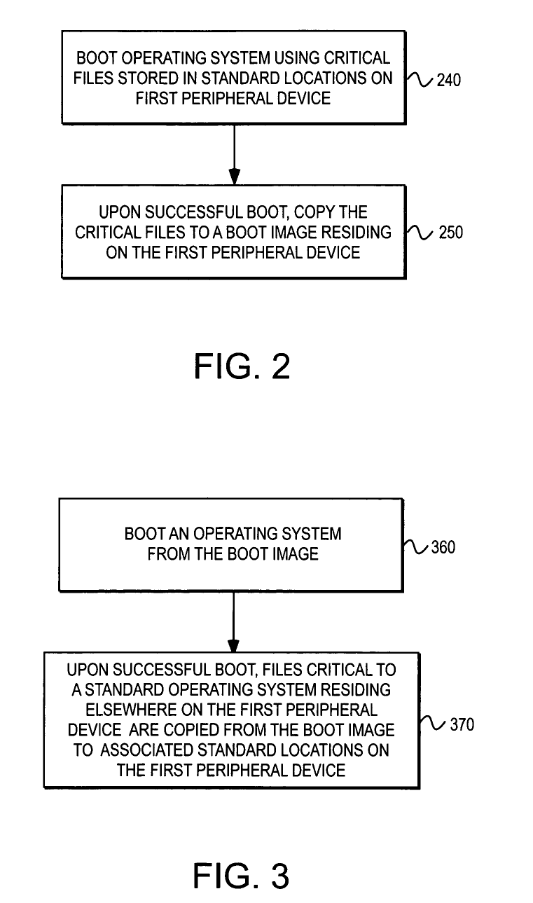

FIG. 2 illustrates the process performed when the pre-existing operating system (i.e., not the boot image) is selected for booting. In step 240, an operating system is booted using critical files in standard locations on the first peripheral device. After a successful boot, the copy script is executed to copy critical files from their associated standard locations on the first peripheral device to the boot image residing on the first peripheral device in step 250. In order to ensure that the critical files are copied upon a successful boot, the copy script may be scheduled as a task to be performed upon a successful boot.

Given that the boot image and the other operating systems are stored on the same first peripheral device, the term “standard” is used to imply locations on the first peripheral device other than the region that the boot image resides on.

Step 250 effectively ensures that the boot image will have copies of critical files that resulted in a successful boot. Critical files may include drivers, bootstrap loaders, boot sector code, operating system kernels, registry hives, etc. A registry hive is a subset of keys appearing in the registry of a Microsoft® Windows® brand operating system. The files deemed critical for a successful boot will depend, of course, upon the hardware configuration and the operating system at issue. The critical files are those files necessary to be able to boot an operating system.

Once the copying has been performed, the user may utilize the computer system as usual. If the user installs hardware or software that modifies the critical files, the copy of the critical files within the boot image will not be modified until after the next successful boot. Thus if the modifications result in an inability to perform a standard boot, the user will be able to boot using the boot image which does not yet incorporate the problematic critical files. On the other hand, once the user successfully reboots the computer system, the boot image will have a copy of the critical files (including any modifications made in the prior session) that have been effectively validated as a result of the successful boot.

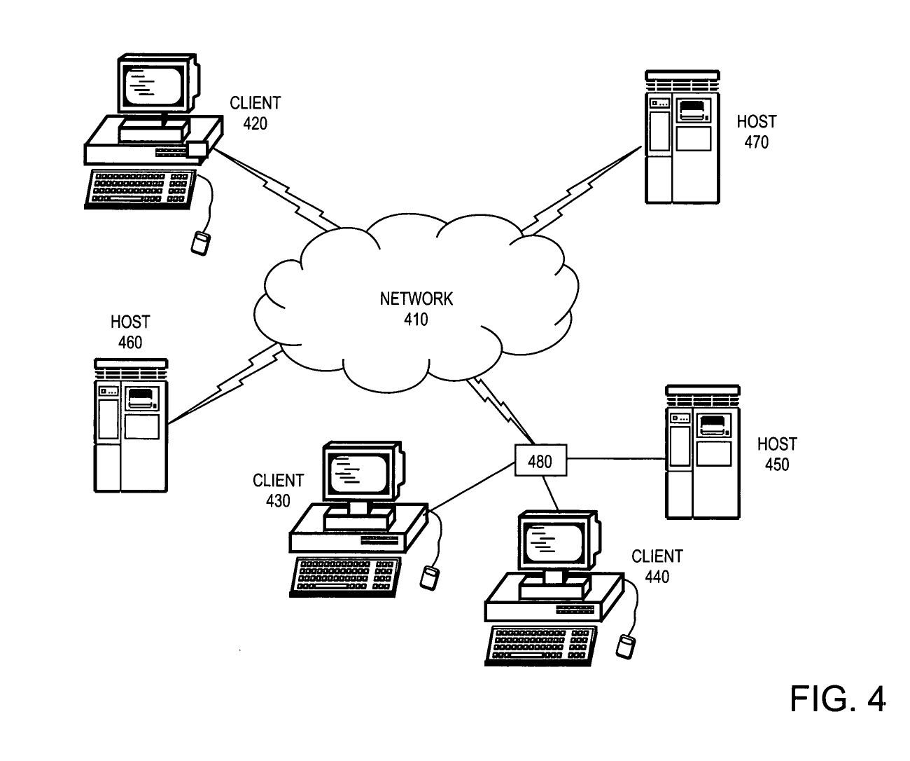

In the event the user is unable to boot using the critical files from the standard locations on the first peripheral device (i.e., the user is unable to perform a standard boot) or the user does not want to perform a standard boot, the user may choose to boot from the boot image. FIG. 3 illustrates the process when the user chooses to boot from the boot image.

In step 360, an operating system is booted from the boot image. Upon a successful boot, the critical files are copied from the boot image to their associated standard locations on the first peripheral device in step 370. The copying may be performed by a restoration program that is executed upon a successful boot of the operating system within the boot image. Similar to the copy script, the restoration program may be scheduled as a task to be performed (within the boot image operating system files) upon a successful boot.

Although the user could continue working under the operating system booted from the boot image, the computer system would preferably be rebooted after step 370 to prevent inadvertent modifications to the critical files stored within the boot image.

The boot image operating system may be the same operating system as the standard operating system such that the boot and standard operating systems are different instances of the same operating system. Alternatively, the boot image operating system and the standard operating system may be distinct operating systems. For example, the boot image operating system could be one of a Unix®, Linux, MS-DOS®, or other non-Microsoft® Windows® operating system while the standard operating system is a Microsoft® Windows® brand operating system. The boot image operating system need not support the full functionality that the standard operating system provides. Even if the boot and standard operating systems are different instances of the same operating system, the boot image operating system may have considerably reduced functionality and size compared to the standard operating system.

The processes illustrated in FIGS. 1-3 enables recovery for some types of errors that may arise within the computer system. Although the boot image, copy script, and boot loader may be distributed by removable media such as a CD, another distribution mechanism may be more suitable for a large number of installations. In particular, the boot image, boot loader, and copy script may be placed upon client computers in a network environment using “push” technologies. Such technologies permit mass distribution to a large base of installed users without the immediate or future need for a peripheral device that supports removable media. Some preliminary discussion of networks, computer architecture, and boot processes is required for further discussion of the recovery processes.

FIG. 4 illustrates a network environment including a communication network 410. Although the network may be an “intranet” designed primarily for access between computers within a private network, in one embodiment network 410 is the network commonly referred to as the Internet. The Internet includes a combination of routers, repeaters, gateways, bridges, and communications links with computers spread throughout the world. The Internet facilitates communication between computers or other devices connected to the Internet.

Some of the computers are referred to as host computers or servers because they provide services upon request. The computers issuing the requests are referred to as client computers. The network environment of FIG. 4 includes multiple (N) client computers (420, 430, 440) and multiple (M) host computers (450, 460, 470). In some cases, a plurality of computers (e.g., 430, 440, 450) may reside on a common network that shares a common connection (e.g., via router 480) to the Internet.

The host computers/servers (e.g., 450) and client computers (e.g., 420) can be entirely different architectures, however, to facilitate communication on network 410 they communicate by using a common communication protocol. In one embodiment, this protocol is the Transmission Control Protocol/Internet Protocol (TCP/IP).

In one embodiment, a client computer 420 accesses a host computer 450 to obtain a boot image file, copy script, and an associated boot loader. The users, for example, may execute a browser application to access a multimedia enhanced document (e.g., a “web page”) residing on a host computer/server from which the user may select the appropriate files to download.

In an alternative embodiment, the files are “pushed” from a server 450 to the client 420. Typically, this requires co-operative components to have already been installed on both the server and client computers. Microsoft Corporation's System Management Server is one example of a product that provides such co-operative components. With the appropriate components installed on each of the server and the client computers, the client will accept software “pushed” to it from the server (i.e., without the client initiating a request for the software). Organizations with a large base of installed users often already have such management tools available to them such that the boot loader, copy script, and boot image may be readily distributed to a large base of users across a network without the need for physical media such as CDs.

Once the boot image is stored on the client computer, additional steps are required to enable the client computer to be able to boot from the boot image. Some understanding of the client computer architecture, standard boot process, and hard disk layout may be helpful in the discussion of the modifications required to make the boot image bootable.

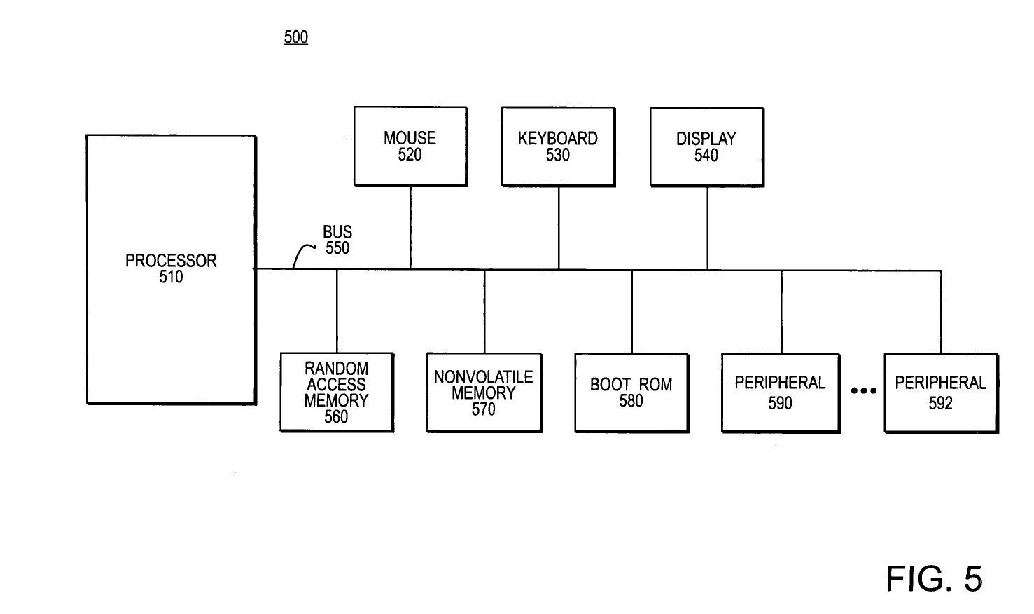

FIG. 5 illustrates one embodiment of a computer architecture. Computer 500 includes processor 510. Input devices such as mouse 520 and keyboard 530 permit the user to input data to client computer 500. Information generated by the processor is provided to an output device such as display 540. Computer 500 includes random access memory (RAM) 560 used by the processor during program execution.

RAM 560 is typically a volatile memory and does not retain its contents once power is removed from the computer system. Computer 500 includes nonvolatile memory 570 for storing configuration information even when the computer is powered down. Often parameter information that identifies specific features of the input/output devices is stored in nonvolatile memory 570. For example, parameter information might describe the number of disk drives, disk drive type, number of heads, tracks, amount of system RAM, etc. as well as the sequence in which peripherals are accessed when attempting to boot the computer (peripheral boot sequence). Various types of nonvolatile media such as electrically erasable programmable read only memory (EEPROM), flash memory, battery-backed complementary metal oxide semiconductor (CMOS) are available.

The computer additionally has one or more peripherals 590, 592 such as a floppy drive, a hard drive, or an optical drive that supports nonvolatile storage. Compact disks (CDs) and Digital Video Disks (DVDs) are examples of media used with optical drives.

Mouse 520, keyboard 530, display 540, RAM 560, nonvolatile memory 570, and boot ROM 580 are communicatively coupled to processor 510 through one or more buses such as bus 550.

Initialization of the computer system is performed upon power-up of the computer system or hardware or software reset operations. In one approach, the processor 510 is designed to read a pre-determined memory location when the processor is reset or powered up. The pre-determined memory location stores a pointer or an address that directs the processor to the beginning of the bootstrap routines. The pointer or address is referred to as a boot vector. For some types of resets (e.g., a “hard” or “cold” reset), the boot vector is always set to a value determined at the time of manufacture of the processor. Other types of resets (e.g., “soft” or “warm” reset) permit an alternative boot vector to be used.

For hard resets, the boot vector typically points to an address in the boot read-only memory (ROM) 580. For soft resets, however, the boot vector may point to a RAM location. The boot ROM stores the bootstrap loader and typically stores other initialization routines such as power on system test (POST). Although referred to as a ROM, the boot ROM is typically embodied at least partially as a re-writable, nonvolatile memory to permit updates.

The boot ROM may include routines for communicating with input/output devices in the computer system. In some computer systems these routines are collectively referred to as the Basic Input Output System (BIOS). The BIOS provides a common interface so that software executing on the processor can communicate with input/output devices such as the keyboard, mouse, nonvolatile mass memory storage device, and other peripheral devices.

The BIOS typically permits the user to boot an operating system from any one of the floppy drive, hard drive, or optical drive. The computer follows the peripheral boot sequence in an attempt to boot from the peripheral devices. Proceeding in boot sequence order, the computer attempts to boot from the first device in the boot sequence that is bootable. One embodiment of a boot process is illustrated in FIG. 6.

Upon initialization, the processor starts executing the BIOS code stored in the boot ROM. The BIOS includes instructions for performing a Power On Self Test as indicated in step 610. The BIOS follows a peripheral boot sequence to locate a boot device in step 620. The BIOS transfers control to code located within the boot sector of the boot device as indicated in step 630. The boot sector code is operating system- and file system-specific. The BIOS, however, is still used to access the boot device.

In some architectures, the user will have the option to select from more than one operating system. Thus in step 640, an operating system to be loaded is selected. Typically, a default operating system is defined and will automatically load unless the user acts within a pre-determined time period. Steps 610-640 are referred to as a “pre-OS boot” phase.

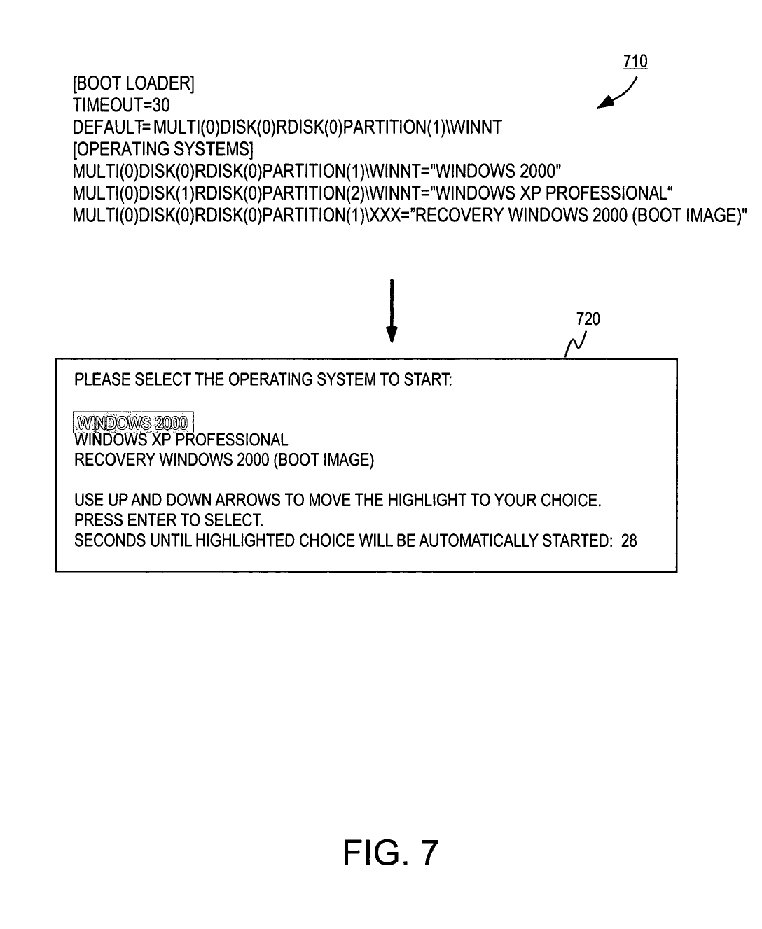

The Microsoft® Windows operating systems family utilizes a file called “boot.ini” for prompting the user to select a particular operating system. FIG. 7 illustrates one embodiment of “boot.ini” file 710 and the corresponding menu 720 generated during the boot process. The boot.ini file typically specifies a default operating system and a timeframe within which the user must act to select an operating system other than the default. In the illustrated embodiment, the default operating system is Windows 2000 and 28 seconds remain for the user to make an alternative selection. The modified boot.ini file permits the user to boot an operating system located within the boot image or an operating system located elsewhere on the first peripheral device. Once the operating system is selected, the boot process continues. In this case the boot.ini file has been modified to refer to the boot loader “bld.com” associated with the boot image.

Referring back to the boot process of FIG. 6, a hardware environment is detected in step 650. Information regarding the computer architecture is collected. The operating system kernel is loaded in step 660. In step 670, the kernel is initialized using the information gathered in step 650. Different peripherals, for example, may require distinct drivers to communicate with the operating system. The information gathered in step 650 aids in the determination of the appropriate drivers to be used by the kernel. In step 680, various services utilized by the operating system (e.g., user authorization) may be loaded. The computer then optionally provides a login authorization in step 690 before permitting access by users. Typically, the operating system is considered to have successfully booted once the user is able to successfully perform a login.

Steps 650-690 are referred to as the operating system boot phase of the boot process. Steps 650-690 are intended to represent a generic operating system boot process. The process may vary depending upon the specifics of the operating system being loaded.

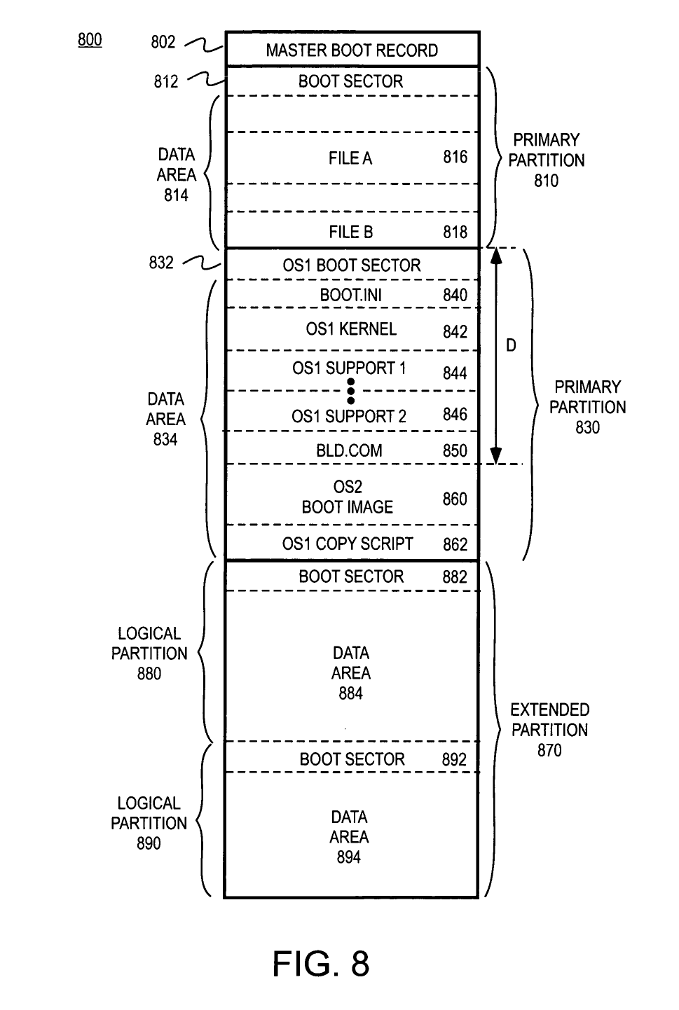

FIG. 8 illustrates one embodiment of a hard drive layout. A hard drive is typically partitioned into one or more contiguous areas 810, 830, 870. Partitions do not overlap each other. A master boot record (MBR 802) resides within the first sector of a partitioned hard drive. The MBR includes MBR code and a partition table defining the locations of various partitions of the hard drive. The code within the MBR is also referred to as the master bootstrap loader. In one embodiment, the hard drive may be partitioned into one or more primary partitions 810, 830. Alternatively, the hard drive may be partitioned into one or more primary partitions 810, 830 and a single extended partition 870.

Each partition includes a data area 814, 834, 884, 894. Extended partitions may be further subdivided into logical partitions 880, 890. Although the location and size of the extended and primary partitions are determined from the MBR partition table, the size of each logical partition 890 is determined by a partition table within the boot sector 892 of that logical partition. The location of each logical partition is determined by the location of the extended partition 870 and the size of any preceding logical partitions 880 within the extended partition as defined by the partition table in their respective boot sectors 882.

One or more files may be stored within the data area of each partition. The file system utilized may vary from partition to partition. The manner of storing and accessing the files is determined by the file system used by that partition. File A 816 and File B 818 may be stored within primary partition 810, for example. A file is the information contained by one or more logically related sectors of the hard drive. The sectors are not necessarily contiguous or sequential, but they do reside within the same partition. If the sectors of a selected file are non-sequential, the file is termed “fragmented”.

During the boot process, peripheral devices are checked in a pre-determined sequence to determine whether they are bootable. A bootable hard drive will have an active partition with an operating system bootstrap loader. Program control is transferred several times to bootstrap ever larger portions of the operating environment until the operating system is booted.

Once program control is transferred to the MBR code, the MBR code locates an active partition 830 from the partition table and transfers control to the code within the boot sector 832 of the active partition 830. The active partition is usually the partition from which the computer will attempt to load the operating system. The first sector of the active partition is the partition boot sector. The code within the active partition boot sector is also referred to as the boot sector bootstrap. The boot sector bootstrap is operating system specific.

The code in the active partition boot sector directs the computer to execute a loader program for loading the operating system. The boot sector code is specific to the file system used by the active partition because it must be able to locate files within the partition. The loader program may be designed to load a specific operating system (e.g., OS1) or the loader program may permit a selection from a variety of operating systems (“multi-boot”). In the illustrated embodiment, the loader is one of the OS1 support files 844-846 that loads the OS1 kernel 842. The loader then proceeds to load the operating system of choice.

Microsoft® Windows® operating systems provide a modifiable file “boot.ini” to permit the user to select a particular instance of the Microsoft® Windows® operating system to boot. Different instances, for example, may load different drivers or may otherwise be tailored for specific applications. In this case, “boot.ini” is modified to append a reference to the boot loader “bld.com” for the boot image and to identify “bld.com” as the default.

When the environment supports multiple operating systems, typically the one designated as the default will be loaded unless the user acts within some pre-determined time frame or otherwise executes an option to prevent the default from being loaded. In one embodiment, the boot loader for the operating system residing within the boot image is designated as the default within the “boot.ini” file so that it will automatically be selected unless the user intervenes. In an alternative embodiment, the user will need to intervene to select the boot image operating system during the boot process.

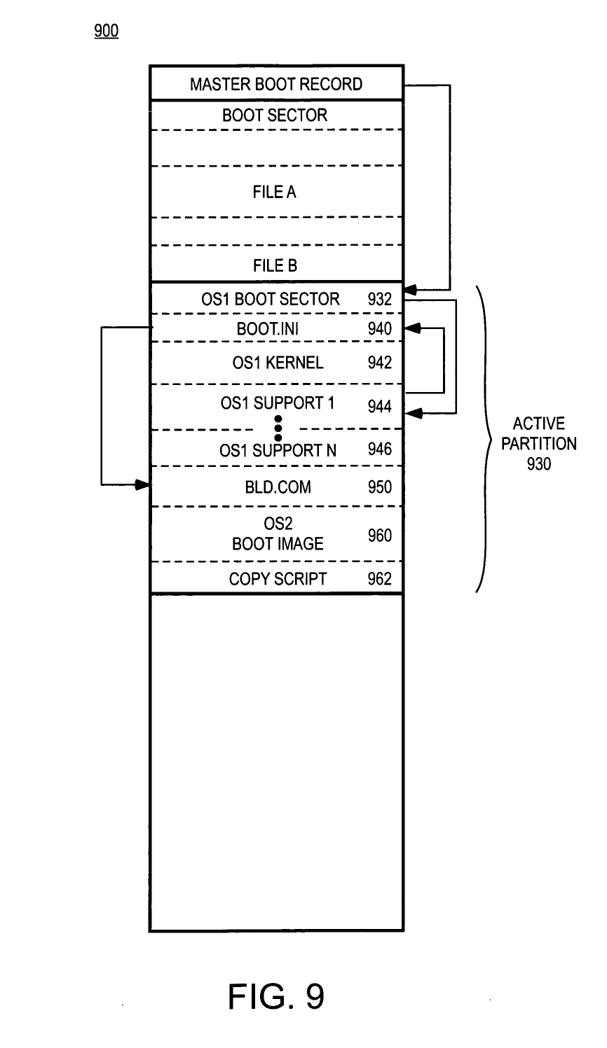

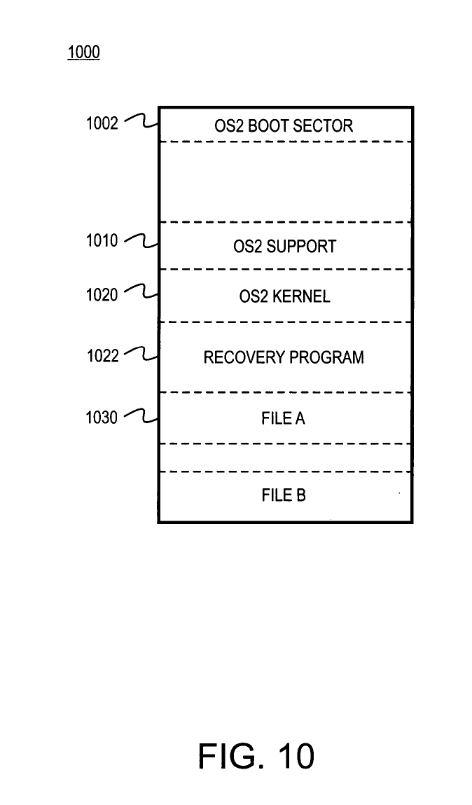

FIG. 9 illustrates one embodiment of a hard disk partition having a boot image. The existing or standard operating system files 940, 942-946 are largely left untouched with the exception of the modification of the “boot.ini” file. The modified “boot.ini” file 940, boot image 960, copy script 962, and boot loader (“bld.com”) 950 now reside within the active partition 930. One embodiment of the boot image is illustrated in FIG. 10.

The boot image 1000 is similar to another partition on the hard drive with the exception that the boot image is a contiguous file. In particular, the boot image includes an operating system kernel (OS2 kernel 1020), the operating system support files 1010, and any other files 1030 deemed appropriate. The boot image includes a boot sector 1002 that functions the same as a boot sector on any other partition of the first peripheral device. The terms “OS1” and “OS2” are intended to further distinguish the operating system that resides within the boot image from the operating system residing on the first peripheral device outside of the region used by the boot image. In one embodiment, OS1 and OS2 are different instances of the same operating system. Alternatively, OS1 and OS2 may be different operating systems.

Preferably recovery should occur in a “trusted” environment. This requires the computer to be booted with a trusted operating system such as the boot image operating system rather than trying to perform the recovery within an operating system or environment that may have been compromised as a result of unknown elements. The active partition boot sector, for example, may be corrupted. In order to ensure that recovery takes place in a trusted environment, the boot loader associated with the boot image enables the boot image to be recognized as a peripheral in the boot sequence so that the computer can be booted from the boot image.

Upon an initial reset, the computer begins the boot process illustrated in FIG. 6. Instead of the typical first operating system boot, however, the boot image boot loader (e.g., “bld.com”) is selected by default or user intervention in step 640.

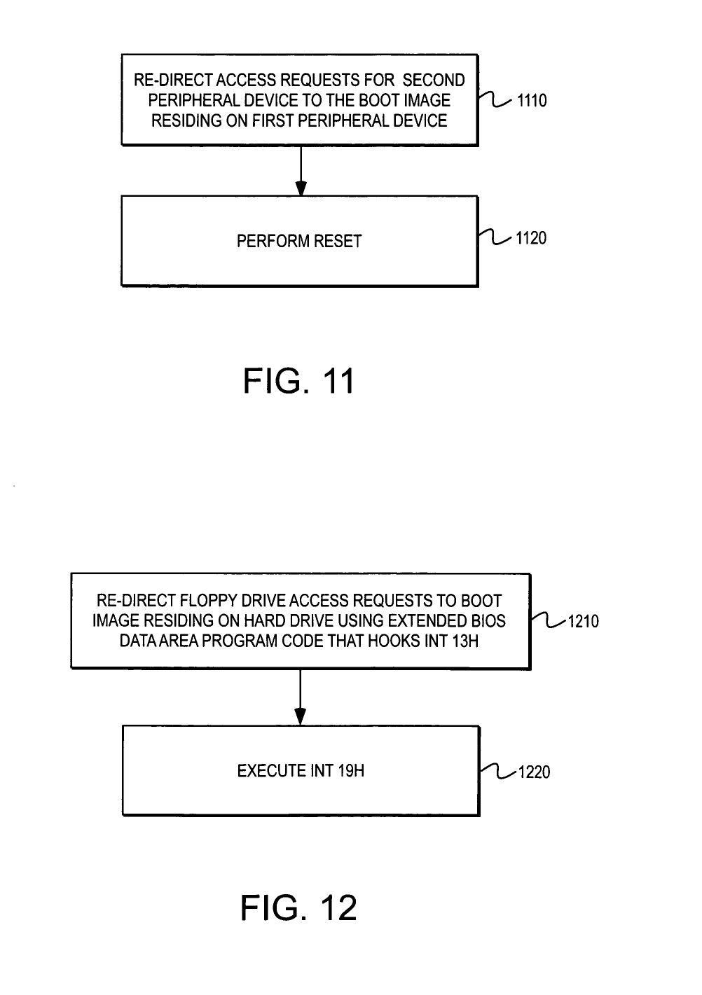

Referring to FIG. 11, the boot image boot loader re-directs access requests targeting a second peripheral device (e.g., a floppy drive) to the boot image residing on the first peripheral device (e.g., the hard drive) in step 1110. The boot image is thus referred to as a virtual floppy drive or virtual hard drive depending upon whether the boot loader code re-directs hard drive access requests or floppy drive access requests to the boot image. In various embodiment, the boot image corresponds to a virtual floppy disk of one of the following capacities: 160 KB, 180 KB, 250 KB, 320 KB, 360 KB, 500 KB, 720 KB, 1.2 MB, 1.44 MB, or 2.88 MB, where “KB” represents kilobytes and MB represents megabytes.

The boot image boot loader then issues an instruction to perform a reset in step 1120. The reset of 1120 is a “soft” reset so that the re-direction instructions are intact upon reset.

FIG. 12 illustrates the application of typical BIOS functions to implement the method of FIG. 11. In step 1210, access requests to a second peripheral device (e.g., floppy drive) are re-directed to the boot image residing on the first peripheral device (e.g., hard drive) by hooking the BIOS function interrupt 13h (INT 13h). Executable program code that hooks interrupt 13h to handle the re-direction is stored in the extended BIOS data area (XBDA). The XBDA is a region of the RAM 560.

A specific sector L of the boot image, for example, begins at the location D+f(L) within the active partition of the first peripheral device. D is the logical block address from the beginning of the active partition to the beginning of the boot image residing on the hard drive. f(L) is a mapping function designed to accommodate for the differences in sector sizes between the second drive that the boot image represents and the first drive that the boot image is actually stored on. The XBDA program code “hooks” the BIOS interrupt 13h function and performs the appropriate mapping to re-direct the access requests. In step 1220, an interrupt 19h (INT 19h) is executed to perform a soft reset.

Although a boot sequence may include a floppy drive, optical drive, and hard drive, the sequence typically starts with the floppy drive. Upon the reset performed by the boot image boot loader, the boot sequence is effectively modified to ensure that floppy drive access requests are directed to the boot image. An attempt to retrieve the boot sector from the first drive (e.g., floppy drive) is re-directed to provide the boot sector within the boot image residing on the hard drive. The boot process continues to load the operating system of the boot image and launch the recovery process. This boot image is sufficient to load an operating system, perform a recovery program to copy critical operating system files from the boot image to the standard locations on the first peripheral device, and exit.

A hard reset should be performed at the conclusion of the recovery to prevent subsequent resets of the computer from automatically booting the boot image as a result of the re-direction. The hard reset eliminates the re-direction (and effective re-sequencing) of the boot sequence that was caused by the boot image boot loader code.

The boot image and associated techniques disclosed permit effectively changing the peripheral boot sequence (at least temporarily) without modifying any parameter data stored in the nonvolatile memory and without performing firmware BIOS modifications. Modification of boot sectors is not required.

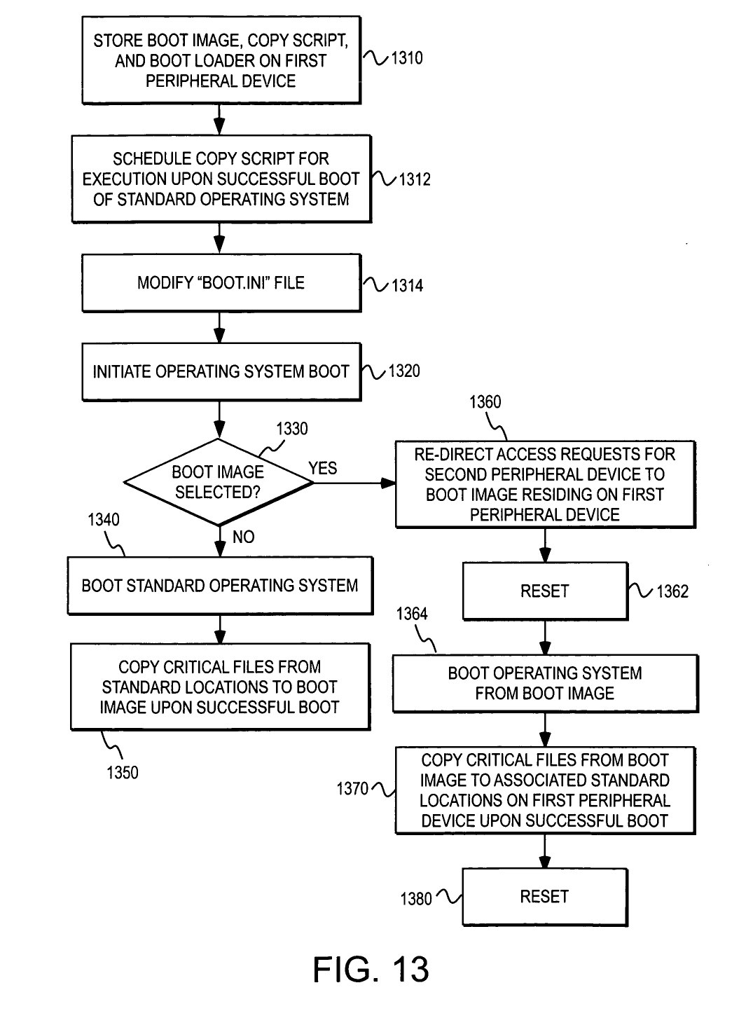

FIG. 13 illustrates an overview of the method for restoring operating system critical files to a first peripheral device. In step 1310, a boot image, copy script, and boot loader are stored on the first peripheral device. In step 1312, the copy script is scheduled for execution upon successful boot of the standard (i.e., non-boot image) operating system. The “boot.ini” file within the active partition of the first peripheral device is modified to include the boot image boot loader in step 1314. An operating system boot is then initiated in step 1320.

If the boot image is not selected as determined by step 1330, then the standard operating system is booted using critical files stored in standard locations (i.e., locations distinct from the boot image) on the first peripheral device in step 1340. Upon a successful boot, the copy script is executed to copy the critical files to the boot image residing on the first peripheral device in step 1350.

If the boot image is selected for booting, then the boot loader (“bld.com”) is executed to re-direct access requests for a second peripheral device to the boot image residing on the first peripheral device in step 1360. The re-direction may be accomplished using program code within the XBDA that hooks BIOS interrupt 13h. The program code includes processor executable instructions for re-mapping access requests from the second peripheral device to the boot image. A reset is then performed in step 1362. The reset of step 1362 is a soft reset to preserve the re-direction instructions. The computer will then proceed through the peripheral boot sequence until it finds a bootable peripheral. The re-direction code ensures that the computer will boot the boot image operating system in step 1364.

Once the boot image operating system is successfully booted, a recovery program within the boot image copies critical files from the boot image to their associated standard locations on the first peripheral device in step 1370. The boot image may be delivered with the recovery program already scheduled to be executed upon successful boot of the boot image operating system. A reset is performed in step 1380 to prevent further activity from altering the critical files within the boot image. The reset of step 1380 is a hard reset to eliminate the re-direction of peripheral device access requests. For example, the hard reset may clear or flush RAM 560 to ensure that the program code stored within the XBDA is eliminated.

Thus methods and apparatus enabling recovery of operating system critical files have been provided. The disclosed techniques enable recovery of critical files without the need for removable media.

In the preceding detailed description, the invention is described with reference to specific exemplary embodiments thereof. Methods and apparatus enabling recovery of certain critical files have been provided. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of operating a computer, comprising:
a) initiating a standard operating system boot process utilizing critical files stored in associated standard locations on a first peripheral device; and
b) copying the critical files from the standard locations into a boot image residing on the peripheral device after a successful boot, wherein the computer can optionally boot from the boot image during a subsequent operating system boot process.

2. The method of claim 1 further comprising:
c) re-directing access requests for a second peripheral device to the boot image residing on the first peripheral device of the computer; and
d) performing a reset, wherein the computer boots an operating system from the boot image.

3. The method of claim 2 wherein step c) further comprises:
i) providing program code to hook a basic input output system (BIOS) function, wherein the program code re-directs access from the second peripheral device to the boot image residing on the first peripheral device; and
ii) performing a soft reset to reset the computer while leaving the program code intact.

4. The method of claim 3 wherein step (a)(i) further comprises hooking the interrupt 13h BIOS function to re-direct access from the second peripheral device to the boot image residing on the first peripheral device.

5. The method of claim 2 further comprising:
e) executing a restoration program to restore critical files from the boot image to their associated standard locations on the first peripheral device.

6. The method of claim 5 wherein the restoration program resides within the boot image.

7. The method of claim 5 further comprising:
f) resetting the computer system to boot the standard operating system using the critical files stored in the associated standard locations.

8. The method of claim 1 further comprising:
c) storing the boot image as a contiguous file on the first peripheral device; and
d) marking the contiguous file to prohibit subsequent fragmentation of the boot image by the standard operating system.

9. The method of claim 2 wherein the first peripheral device is a hard disk drive, wherein the second peripheral device is a floppy disk drive.

10. A method of operating a computer, comprising:
a) storing a boot loader and a boot image on a first peripheral device, wherein the computer system can optionally boot from the boot image; and
b) copying files critical to a successful standard operating system boot from their associated standard locations on the first peripheral device into the boot image after a successful boot from the first peripheral device.

11. The method of claim 10 further comprising:
c) performing a reset, wherein the boot loader is executed upon the reset to re-direct access of a second peripheral device to the boot image residing on the first peripheral device; and
d) performing a reset, wherein an operating system residing within the boot image is loaded in response to requests to boot from the second peripheral device.

12. The method of claim 11 wherein the first peripheral device is a hard disk drive, wherein the second peripheral device is a floppy disk drive.

13. The method of claim 10 further comprising:
c) copying the critical files from the boot image to their associated standard locations on the first peripheral device, if the computer system is booted from the boot image.

14. The method of claim 13 further comprising:
d) resetting the computer system to boot the standard operating system from the first peripheral device.

15. The method of claim 10 wherein the boot image is marked to prevent fragmentation by the standard operating system.

16. A method of operating a computer, comprising:
a) initiating a computer operating system boot from a boot image residing on a first peripheral device; and
b) copying critical files for a standard operating system residing elsewhere on the first peripheral device from the boot image to associated standard locations on the first peripheral device after a successful boot from the boot image.

17. The method of claim 16 wherein step a) further comprises:
i) providing program code to hook a basic input output system (BIOS) function, wherein the program code re-directs access from a second peripheral device to the boot image residing on the first peripheral device; and
ii) performing a soft reset to reset the computer while leaving the program code intact.

18. The method of claim 17 wherein the first device is a hard disk drive, wherein the second peripheral device is one of an optical and a floppy drive.

19. The method of claim 17 further comprising:
c) performing a reset, wherein the program code for re-direction is eliminated.

20. The method of claim 18 wherein the critical files residing in the standard locations support a standard operating system, wherein the standard operating system and the boot image operating system are distinct instances of the same operating system.

21. The method of claim 18 wherein the critical files residing in the standard locations support a standard operating system, wherein the standard operating system and the boot image operating system are distinct operating systems.

22. A method of operating a computer, comprising:
a) means for booting a computer utilizing critical files stored in associated standard locations on a peripheral device; and
b) means for copying the critical files from the standard locations into a bootable image residing on the peripheral device after a successful boot.

23. An apparatus comprising:
a computer usable medium storing processor-executable instructions, wherein subsequent a standard operating system boot process utilizing critical files stored in associated standard locations on a first peripheral device, the instructions cause the computer to copy the critical files from the standard locations into a boot image residing on the peripheral device after a successful boot.
